(19) United States
(12) Patent Application Publication
(10) Pub. No.: US 2024/0416688 A1
(43) Pub. Date: Dec. 19, 2024

(54) AUTO-LOCATION METHOD FOR SENSORS IN OR ON VEHICLES

(71) Applicant: Robert Bosch GmbH, Stuttgart (DE)

(72) Inventor: Ouael HAJJI, Stuttgart (DE)

(21) Appl. No.: 18/700,129

(22) PCT Filed: Oct. 12, 2022
(86) PCT No.: PCT/EP2022/078333

§ 371 Date: May 14, 2024

(30) Foreign Application Priority Data
Oct. 13, 2021 (DE) 10 2021 211 563.2

(51) Int. Cl. B60C 23/04

(52) U.S. Cl. CPC B60C 23/0415; B60C 23/0474; B60C 23/0488

(57) ABSTRACT

An auto-location method for sensors in or on vehicles, in particular TPMS sensors. The method includes: establishing a bidirectional communication between a central unit and at least one sensor; ascertaining trigger data for the auto-location of the at least one sensor on the basis of vehicle state data which are provided to the central unit by at least one other vehicle unit; transmitting the trigger data to the at least one sensor; initiating the auto-location by means of the central unit on the basis of the trigger data, wherein the sensor ascertains sensor data for the auto-location; and ascertaining the position of the at least one sensor on the basis of the ascertained sensor data.

### FIELD

The present invention relates to a method for the auto-location of sensors in or on vehicles, in particular TPMS sensors.

The present invention also relates to a system for the auto-location of sensors in or on vehicles, in particular TPMS sensors.

The present invention also relates to a vehicle comprising a system.

Although the present invention is generally applicable to any sensors, the present invention is described with reference to TPMS sensors on tires of a vehicle.

### BACKGROUND INFORMATION

In tire pressure monitoring systems, or TPMS systems for short, which use unidirectional communication between a central unit and the TPMS sensors, the auto-location function is based on the look-back time data or the rotation period of the wheel, which is sent from a sensor located on the tire to a receiver on or in the vehicle. This is done asynchronously when the sensor detects the necessary conditions for auto-location and usually takes several minutes, because there is no feedback from the receiver. The receiver also detects the necessary conditions for auto-location and begins collecting sensor data, which it correlates with other vehicle tire rotation data to assign each TPMS sensor a position on the vehicle.

Auto-location in unidirectional communication systems (sensor to vehicle receiver) takes a very long time and is influenced by many parameters. The sampling rates of the TPMS sensor depend heavily on the vehicle speed and the rim size. Road conditions, driving behavior and even a possible mounting error of the TPMS sensor have a major influence on the TPMS sensor calculation of the acceleration signals into values such as look-back time and/or revolution duration, which are used by the receiver to assign a location to each sensor. To this end, a user manual for vehicles using this method regularly asks the vehicle user to take the vehicle for a 20-minute drive, during which the vehicle user is often asked to maintain a low driving speed, for example below 25 km/h. This is extremely time-consuming and user-unfriendly, especially because this process takes a correspondingly long time. In addition, the respective conditions for the start of auto-location may be unfavorable. The sensor data are also continuously collected and processed. As a result, a significant proportion of the energy available for the sensors is used for auto-location, as this process typically takes place every time the vehicle transitions from idle mode, i.e., a long standstill, to driving mode.

### SUMMARY

In one example embodiment, the present invention provides an auto-location method for sensors in or on vehicles, in particular TPMS sensors, having the steps of:
establishing a bidirectional communication between a central unit and at least one sensor,
ascertaining trigger data for the auto-location of the at least one sensor on the basis of vehicle state data which are provided to the central unit by at least one other vehicle unit,
transmitting the trigger data to the at least one sensor,
initiating the auto-location by means of the central unit on the basis of the trigger data, wherein the sensor ascertains sensor data for the auto-location, and
ascertaining the position of the at least one sensor on the basis of the ascertained sensor data.

In one example embodiment, the present invention provides a system for the auto-location of sensors in or on vehicles, in particular TPMS sensors, comprising
a central unit,
a vehicle unit, and
at least one sensor, in particular an acceleration and/or angular rate sensor, wherein a bidirectional communication can be established between the central unit and the at least one sensor, and wherein the central unit is designed to ascertain trigger data for the auto-location of the at least one sensor on the basis of vehicle state data which are provided to the central unit by the vehicle unit, to transmit the trigger data to the at least one sensor, and to initiate the auto-location on the basis of the trigger data, wherein the sensor ascertains sensor data for the auto-location, and to ascertain the position of the at least one sensor on the basis of ascertained sensor data, and wherein the at least one sensor is designed to receive trigger data from the central unit, to ascertain sensor data for the auto-location after initiation and to transmit ascertained sensor data to the central unit.

In one example embodiment, the present invention provides a vehicle comprising a system.

One of the advantages achieved is improved auto-location of the at least one sensor, because the sensor is provided with the required parameters, thus reducing the complexity of its calculations and the dependence on vehicle and wheel parameters. In addition, energy is saved overall because suitable conditions for auto-location are calculated by the central unit and auto-location is then carried out during these conditions.

Further features, advantages and further embodiments of the present invention are described below or are disclosed thereby.

According to an advantageous further development of the present invention, a time window for initiating auto-location is ascertained and a sampling rate for the sensor is ascertained on the basis of the ascertained time window, which rate is provided to the sensor for ascertaining the sensor data at the sampling rate. This reduces energy consumption, particularly on the sensor side, because the sensor value for auto-location is ascertained in an improved, if not optimal, time window.

According to a further advantageous further development of the present invention, the sampling rate is ascertained on the basis of vehicle state data, in particular on the basis of vehicle movement data. The advantage of this is that a suitable sampling rate can be ascertained easily and reliably.

According to a further advantageous further development of the present invention, a transmission of data between the sensor and the central unit is confirmed by the receiving side of the transmission. One of the advantages achieved is an increase in the reliability of auto-location.

According to a further advantageous further development of the present invention, auto-location is initiated on the basis of information, in particular a flag, provided to the sensor by the central unit. This is a particularly simple and simultaneously reliable way to initiate auto-location.

According to a further advantageous further development of the present invention, the sensor data of the sensor are transmitted to the central unit until the position of the sensor has been ascertained with predetermined accuracy. This avoids unnecessary calculations for ascertaining the position of the sensor.

According to a further advantageous further development of the present invention, the bidirectional communication is switched off once the position of the sensor has been ascertained. This is a simple way to save energy.

According to a further advantageous further development of the present invention, the sensor is provided as an inertial measurement sensor, in particular in the form of an acceleration sensor and/or an angular rate sensor. Using such a sensor, suitable data for auto-location can be obtained easily and reliably.

Further important features and advantages of the present invention can be found in the disclosure herein.

It is self-evident that the features mentioned above and those still to be explained below can be used not only in the combination specified in each case, but also in other combinations or alone, without departing from the scope of the present invention.

Preferred designs and embodiments of the present invention are illustrated in the figures and are explained in more detail in the following description, wherein the same reference signs refer to identical or similar or functionally equivalent components or elements.

### BRIEF DESCRIPTION OF THE DRAWINGS

FIG. 1 shows steps of a method according to one example embodiment of the present invention.

FIG. 2 shows steps of a method according to one example embodiment of the present invention.

FIG. 3 shows a system according to one example embodiment of the present invention in schematic form.

### DETAILED DESCRIPTION OF EXAMPLE EMBODIMENTS

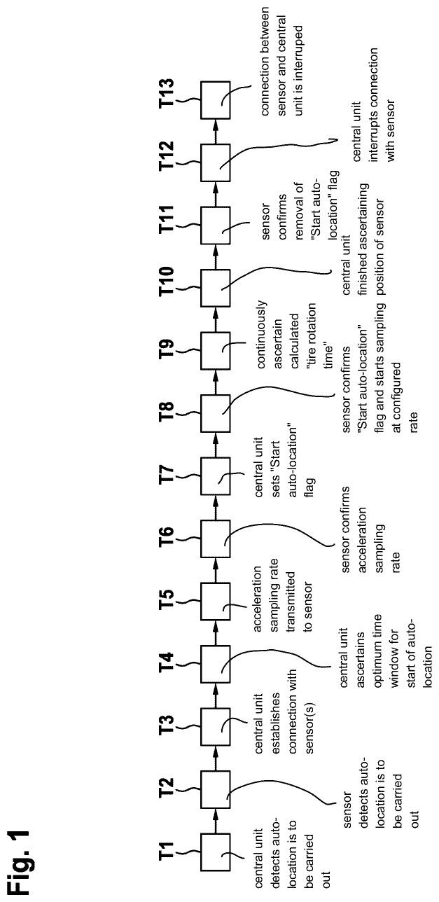

FIG. 1 shows steps of a method according to one embodiment of the present invention.

FIG. 1 shows steps of a method for the auto-location of a sensor of a system in a vehicle, which comprises the sensor, in this case a TPMS sensor, and a central unit.

In a first step T1, a central unit, also referred to below as a gateway, detects that an auto-location is to be carried out. This is the case, for example, if the vehicle has not been moved for a long time, i.e., the vehicle makes a transition from a long standstill to a driving state. The central unit then begins to search for connectable TPMS sensors in the immediate vicinity.

In a further step T2, the sensor, which is designed in particular as an acceleration sensor, also detects that an auto-location is to be carried out. The sensor starts sending connection indications, but without first taking acceleration measurements.

In a further step T3, the central unit establishes a connection with one or more connectable TPMS sensors.

In a further step T4, the central unit uses input data, for example from a control unit of the vehicle, such as ABS, ESP, turn signal control, steering ECU, and the like, to ascertain an optimum time window for the start of auto-location. An optimum window is achieved, for example, when the road has no bumps and when the vehicle is making a turn.

In a further step T5, as soon as the central unit has identified the optimum time window, the acceleration sampling rate is transmitted to the TPMS sensor by means of bidirectional communication. The acceleration sampling rate is derived in particular from the current vehicle speed of the vehicle, but can alternatively or additionally also be derived from other information provided about the vehicle movement and driving conditions. The acceleration sampling rate can be available as a frequency, period or in another format or can be converted accordingly.

In a further step T6, the TPMS sensor confirms the acceleration sampling rate received from the central unit or gateway.

In a further step T7, the central unit sets a “Start auto-location” flag for the TPMS sensor.

In a further step T8, the TPMS sensor confirms the provided “Start auto-location” flag and starts sampling at the configured sampling rate.

In a further step T9, the TPMS sensor uses its notification function to continuously ascertain the calculated “tire rotation time” until it receives the instruction to stop from the gateway. It is also possible to calculate and transmit a plurality of values for the “tire rotation time” depending on the corresponding implementation or realization. The “tire rotation time” parameter can be available as a frequency, period or in another format or can be converted accordingly.

In a further step T10, when the central unit has finished ascertaining the position of the sensor, for example front right, front left, rear right, rear left in relation to the TPMS sensor with which it is communicating, the central unit removes the “Start auto-location” flag.

In a further step T11, the TPMS sensor confirms the removed “Start auto-location” flag, and the acceleration sampling is terminated.

In a further step T12, which is optional, the central unit interrupts the connection with the TPMS sensor of which the position has already been ascertained.

In a further step T13, the connection between the TPMS sensor and the central unit is interrupted and the TPMS sensor switches to standard mode and provides tire pressure data again.

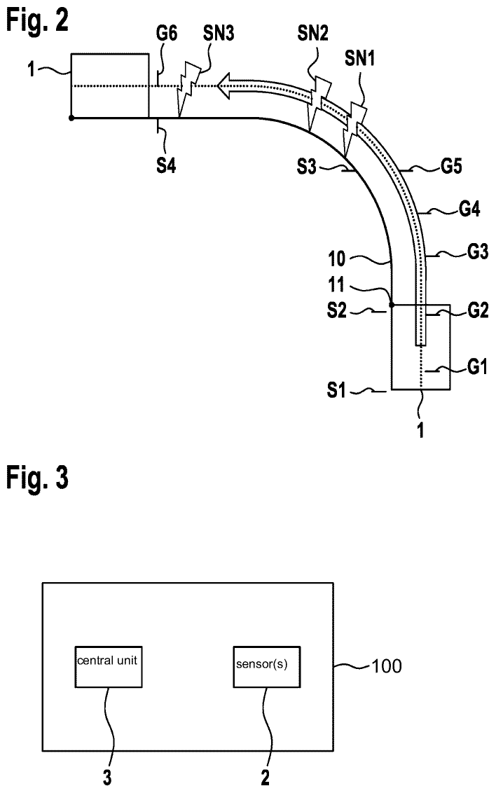

FIG. 2 shows steps of a method according to one embodiment of the present invention.

FIG. 2 shows the path 10 of the front left wheel 11 of a vehicle 3 making a 90-degree left turn. In the initial position of the vehicle-bottom right in FIG. 2—the sensor 2 in step S1 is set to the state for establishing a connection with a central unit. At the same time, the central unit 3 scans for sensors to be connected in its vicinity in step G1 after step S1. In the present exemplary embodiment, the successful connection is now established in step G2. The sensor then determines in step S2 that it is now connected to the central unit 3. As the curve progresses, the central unit 3 now checks in step G3 whether the conditions for auto-location of the sensor are present. This is configured in step G4 and initiated in step G5. The sensor now carries out the auto-location in step S3, in which the sensor continuously provides data for the auto-location of the central unit. In steps SN1-SN3, the corresponding data are made available to the central unit.

Auto-location is then terminated by the sensor in step S4. The central unit 3 also ends the calculations of the position of the sensor and the auto-location as a whole if it was possible to determine the position of the sensor.

FIG. 3 is a schematic representation of a system according to one embodiment of the present invention.

FIG. 3 shows a system 100 for the auto-location of sensors in or on vehicles, in particular TPMS sensors.

The system 100 is arranged in a vehicle and comprises a central unit 3 and at least one sensor 2, in particular an acceleration and/or angular rate sensor, wherein a bidirectional communication can be established between the central unit 3 and the at least one sensor 2, and wherein the central unit 3 is designed to ascertain trigger data for the auto-location on the basis of vehicle state data provided to the central unit 3, to transmit the trigger data to the at least one sensor 2, to initiate the auto-location on the basis of the trigger data, wherein the sensor ascertains sensor data for the auto-location, and to ascertain the position of the at least one sensor 2 on the basis of ascertained sensor data, and wherein the at least one sensor 2 is designed to receive trigger data from the central unit 3, to ascertain sensor data for the auto-location after initiation and to transmit ascertained sensor data to the central unit 3.

In summary, at least one of the embodiments has the following features and/or advantage:
Simple sensors possible. For example, a simple acceleration sensor is sufficient.
Quick and easy determination of the position of the sensor.
Energy savings.
High degree of independence from strongly influencing parameters, such as different rims, rim sizes and mounting defects of the TPMS sensor.

In other words, only the gravitational acceleration axis is needed for auto-location in at least one of the embodiments, because the TPMS sensor receives the acceleration sampling rate from the central unit and does not need to calculate it from the centrifugal acceleration axis. The auto-location is performed on request and with continuous feedback from the central unit when an optimum window is detected. This is faster and more reliable than previous implementations. The synchronous execution of the auto-location algorithms on the TPMS sensor and the central unit makes operation generally more energy-efficient and accurate. The ability to report the tire speed makes the embodiments of the present invention independent of highly influential parameters, such as different rims, rim sizes and mounting defects of the TPMS sensor.

Although the present invention has been described with reference to preferred exemplary embodiments, it is not limited thereto, but can be modified in many ways.

1-10. (canceled)

11. An auto-location method for a sensor in or on a vehicle, the method comprising the following steps:
establishing a bidirectional communication between a central unit and at least one sensor;
ascertaining trigger data for an auto-location based on vehicle state data which are provided to the central unit;
transmitting the trigger data to the at least one sensor;
initiating the auto-location using the central unit;
starting ascertainment of sensor data for the auto-location by the at least one sensor after the initiation; and
ascertaining a the position of the at least one sensor based on the ascertained sensor data.

12. The method according to claim 11, wherein the sensor is a TPMS sensor.

13. The method according to claim 11, wherein a time window for initiating the auto-location is ascertained, and a sampling rate for the sensor is ascertained based on the ascertained time window, the sampling rate being provided to the sensor for ascertaining the sensor data at the sampling rate.

14. The method according to claim 13, wherein the sampling rate is ascertained based on the vehicle state data, including based on vehicle movement data.

15. The method according to claim 11, wherein a transmission of data between the sensor and the central unit is confirmed by a receiving side of the transmission.

16. The method according to claim 11, wherein the auto-location is initiated based on a flag provided to the sensor by the central unit.

17. The method according to claim 11, wherein the sensor data of the sensor are transmitted to the central unit until the position of the sensor has been ascertained with predetermined accuracy.

18. The method according to claim 11, wherein the bidirectional communication is switched off once the position of the sensor has been ascertained.

19. The method according to claim 11, wherein the sensor is an inertial measurement sensor in the form of an acceleration sensor and/or an angular rate sensor.

20. A system for an auto-location of a sensor in or on a vehicle, comprising
a central unit; and
at least one sensor, wherein a bidirectional communication can be established between the central unit and the at least one sensor, and wherein the central unit is configured to ascertain trigger data for the auto-location based on vehicle state data which are provided to the central unit, to transmit the trigger data to the at least one sensor, and to initiate the auto-location based on the trigger data, wherein the sensor ascertains sensor data for the auto-location, and wherein the central unit is configured to ascertain a position of the at least one sensor based on the ascertained sensor data, and wherein the at least one sensor is configured to receive the trigger data from the central unit, to ascertain sensor data for the auto-location after initiation and to transmit ascertained sensor data to the central unit.

21. The system according to claim 20, wherein the at last one sensor includes an acceleration sensor and/or angular rate sensor.

22. A vehicle, comprising:
a system for an auto-location of a sensor in or on the vehicle, including:
a central unit; and
at least one sensor, wherein a bidirectional communication can be established between the central unit and the at least one sensor, and wherein the central unit is configured to ascertain trigger data for the auto-location based on vehicle state data which are provided to the central unit, to transmit the trigger data to the at least one sensor, and to initiate the auto-location based on the trigger data, wherein the sensor ascertains sensor data for the auto-location, and wherein the central unit is configured to ascertain a position of the at least one sensor based on the ascertained sensor data, and wherein the at least one sensor is configured to receive the trigger data from the central unit, to ascertain sensor data for the auto-location after initiation and to transmit ascertained sensor data to the central unit.
